(19) United States
(12) Patent Application Publication
(10) Pub. No.: US 2010/0191758 A1
(43) Pub. Date: Jul. 29, 2010

(54) SYSTEM AND METHOD FOR IMPROVED SEARCH RELEVANCE USING PROXIMITY BOOSTING

(75) Inventors: Fuchun Peng, Sunnyvale, CA (US); Xing Wei, Santa Clara, CA (US); Yumao Lu, San Jose, CA (US); Xin Li, Sunnyvale, CA (US); Donald Metzler, Santa Clara, CA (US); Hang Cui, Sunnyvale, CA (US); Benoit Dumoulin, Palo Alto, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 12/360,008

(22) Filed: Jan. 26, 2009

(51) Int. Cl. G06F 17/30

(52) U.S. Cl. 707/759; 707/E17.015; 707/E17.017; 707/E17.108

(57) ABSTRACT

A system and method for improved search relevance using proximity boosting. A query for a web search is received from a user, via a network, wherein the query comprises a plurality of query tokens. One or more concepts are identified in the query wherein each of concepts comprises at least two query tokens. A relative concept strength is determined for each of the identified concepts. The query is then rewritten for submission to a search engine wherein for each of the one or more concepts, a syntax rule associated with the respective relative concept strength of the concept is applied to the query tokens comprising the concept such that the rewritten query represents the one or more concepts whereby the proximity of the one or more concepts in a search result returned by the search engine to the user in response to the rewritten query is boosted.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to systems and methods for improving the relevance of the results returned by web searches and, more particularly, to systems and methods improving the relevance of the results returned by web searches using proximity boosting techniques.

### BACKGROUND OF THE INVENTION

Web search engines such as Yahoo! and Google allow end users to search for web pages, images, videos and other forms of electronic content available via the Internet relating to an almost unlimited number of topics. Web search interfaces are designed to be flexible and easy to use. Typically, a web search query interface allows users to enter in a query consisting of a string of words that describe the content sought.

Unfortunately, a query consisting of nothing more than a string of words can be ambiguous both as to content sought and the relative importance of concepts embodied within the query. For example, a user interested in cars for sale in northern California may enter a query such as “car sales northern california.” A web search engine receiving such as query may search for any web pages containing a combination of some or all of the words in the query. Such pages could represent the content the user is interested in, but could also represent content of no interest. For example, such pages could include car sales anywhere in California, sales of things other than cars in northern California, or, even worse, pages including all of the words in the query, but each word in a separate sentence or paragraph.

Web search results are typically enhanced by ranking the results by relevance. However, many algorithms and techniques used for ranking may also fail to adequately capture the user's intent. For example, if a query is treated as a bag of words and documents are ranked using, for example, a naive Bayes classifier, documents may be ranked merely on the basis of the frequency with which the query words appear in the document even if the document does not relate to content relevant to the user's interests.

These problems may be referred to as proximity issues, i.e. query words do not occur close together or in the proper order in documents or web pages. This is especially problematic for long queries when a query contain many words. What is needed are systems and methods that boost the proximity of query words to one another in search results in a manner that reflects the intent of the persons submitting the queries.

### SUMMARY OF THE INVENTION

In one embodiment, the invention is a method. A query for a web search is received from a user, via a network, wherein the query comprises a plurality of query tokens. One or more concepts are identified in the query, using at least one computing device, wherein each of concepts comprises at least two query tokens of the plurality of query tokens. A respective relative concept strength is determined using the computing device, for each of the identified concepts. The query is then rewritten for submission to a search engine, using the at least one computing device, wherein for each of the one or more concepts, a syntax rule associated with the respective relative concept strength of the concept is applied to the query tokens comprising the concept, such that the rewritten query represents the one or more concepts.

In another embodiment, the invention is a system comprising: a query receiving module that receives queries for a web searches from a user, via a network, wherein each query comprises a plurality of query tokens; a concept identification module that identifies one or more concepts in each query received by the query receiving module, wherein each of the concepts comprises at least two query tokens of the plurality of query tokens; a concept strength determination module that determines a respective relative concept strength for each of the concepts in each query processed by the concept identification module; and a query rewriting module that rewrites each query processed by the concept identification module and the concept strength determination module for submission to a search engine, wherein for each of the concepts within each query, a syntax rule associated with the respective relative concept strength of the concept is applied to the tokens comprising the concept, such that the rewritten queries represent the one or more concepts.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 illustrates a high-level diagram of a system capable of supporting at least one embodiment of a system for improved search relevance using proximity boosting.

FIG. 2 illustrates one embodiment of a process for improved search relevance using query rewriting to boost proximity in search results.

FIG. 3 illustrates one embodiment of a query rewriting engine and a search engine capable of supporting at least one embodiment of the process shown in FIG. 2.

### DETAILED DESCRIPTION

The present invention is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions.

These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure the term “end user” or “user” should be understood to refer to a consumer of data supplied by a data provider. By way of example, and not limitation, the term “end user” can refer to a person who receives data provided by the data provider over the Internet in a browser session, or can refer to an automated software application which receives the data and stores or processes the data.

For the purposes of this disclosure, a computer readable medium stores computer data in machine readable form. By way of example, and not limitation, a computer readable medium can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other mass storage devices, or any other medium which can be used to store the desired information and which can be accessed by the computer.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may grouped into an engine or an application.

The present invention is directed to systems and methods for improved search result relevance, both in the content returned in search results and in the ranking of search results using various techniques to boost proximity of search terms within such search results as described in more detail below.

In a typical web query, a user enters in an unstructured string of words or other tokens relating to one or more topics of interest to the user. As in the example above, a user interested in cars for sale in northern California may enter a query such as “car sales northern california.” A web search engine may treat the query simply as a bag of words for the selection and ranking of content. A human can readily recognize, however, that the four words probably relate to two concepts, “car sales” and “northern california.” This may be relatively obvious even with a different word order, e.g. “sales california north cars.”

When a query is treated as a bag of words, however, search results can suffer from serious proximity issues where query terms which, ideally should occur close together in the search results, are far apart, or appear in an illogical order in documents in the search result. This is especially problematic for long queries that contain many words. In the example above, documents where the terms “northern” and “california” appear in separate paragraphs, or appear in the same sentence, but in a different order, may not be relevant.

Search result relevance could be improved by treating unstructured web queries not as simple bag of words, but rather as one or more related concepts such that content is searched and ranked according to concepts embedded in the content. For the purposes of this disclosure the term “concept” should be understood to refer to two or more words or tokens in a query that, when taken as a unit, and possibly in a specific order, refer or relate to a person, place, object or idea.

Thus, in another example, suppose a user is interested in events occurring in Central Park in New York on weekends in the summer of 2009. A user might enter the query “events central park new york weekend summer 2009.” The query contains concepts including:
“central park”
“new york”
“central park new york”
“summer 2009”
“summer 2009 weekend”

An unstructured query can potentially contain as many concepts as there are unique combinations and permutations of 2 or more of the words in the query. For example, a query of 4 unique words many contain (ignoring word order) 6 unique combinations of two words, 4 unique combinations of 3 words and 1 unique combination of 4 words. If word order is significant, a query of 4 unique words many contain 12 unique permutations of two words 18 unique permutations of 3 words and 24 permutations of 4 words.

Every combination of words in a query, however, does not represent a useful concept. For example, ‘york central park” may have no meaning if York (U.K.) doesn't have a Central Park, and “new central”, “new 2009”, “central 2009” are nonsensical and “york new” and “park central” are ambiguous. Furthermore, some concepts are more useful than others because they are more specific. For example, “summer 2009 weekend” is more specific that “summer 2009”, e.g. midweek events occurring in Summer 2009 may be of little or no interest.

The usefulness of a concept can be referred to as the relative strength of the concept. The relative strength of concept can be regarded as, without limitation a measure of the extent to which the words of the concept identify a specific topic with specificity, precision and minimal ambiguity. In one embodiment, a scale of relative concept strengths can be defined as:
category 0: very strong concepts where the words within a concept have to be in the same order and do not allow insertion/deletion of words,
category 1: strong concepts where words within a concept have to be in the same order, but allow word insertion/deletion,
category 2: weak concepts where words can both reverse order and allow word insertion/deletion,
category 3: not a concept (words are not related.)

For example in the example above:
“central park” and “new york” have a relative strength of 0,
“central park new york” has a relative strength of 1 (e.g. the string “Central park in the heart of New York” is a match notwithstanding the insertion of “in the heart of”,
“summer 2009” and “summer 2009 weekend” are arguably in category 2 since the order and position of the words can vary,
“events” is category 3, since the word is arguably unrelated to any concept comprising two or more words (i.e. is not a concept.)

The categorization scheme as shown above is illustrative, and is not intended to be limiting. Other categorization schemes are possible which may, for example, contain more or fewer categories and which may use different or additional criteria to evaluate the relative strength of a concept. For example, the relative strength of a concept may be based in part on the number of words in the concept (e.g. four words is stronger than 2.)

In one embodiment, a classifier or segmenter can be trained to identify concepts in a web query and their relative strengths using training data including a large number of queries (e.g. 10,000 queries taken from a query log) which have been manually labeled by editors One example of such a segmenter could be a segmenter using Conditional Random Fields. In one embodiment each concept is associated with confidence scores calculated based on language modeling, and based on machine learning. In one embodiment, the confidence score is used to determine relative concept strength. It will be readily apparent to those skilled in the art, however, that other statistical or supervised machine learning techniques known in the art could be applied to identify concepts embodied in a web query.

Once the concepts in a query are identified, various techniques can be utilized to improve the relevance of the search results returned by a query by boosting the proximity of query terms in a manner suggested by the strength of concepts embodied within the query. In one embodiment, one technique for improving the results returned by a query is to automatically rewrite the query before submitting the query to a search engine to boost proximity in search results by optimizing retrieval or ranking of concepts identified in the query.

Referring back to the example illustrated above, “events central park new york weekend summer 2009”, once the concepts within the query are identified as shown above, a improved query could be composed using such concepts. For example, an improved query could search for documents where:
The category 0 concepts “central park” and “new york” are literally present in search results, with the words in the same order, and with no insertion of additional words.
The category 1 concept “central park new york” is present in the search results, with the words in the same order, but with intervening words.
The category 2 concept “summer 2009” “summer 2009 weekend” are present in the search results, with the words placed in any order and in any position in the search results.
The remaining query term “events” is in the search results

In one embodiment, each relative concept strength within a categorization scheme (such as that described above) is associated with one or more syntax rules. In a given query, the syntax rules are applied to the tokens within each concept to identify, reformat or restate the concept in a form that improves the relevance of search results retrieved by a search engine. At least two rewriting strategies may be embodied in such syntax rules. In the first strategy, the query can be rewritten to boost proximity by better utilizing the existing query syntax supported by a target search engine.

The exact form taken by the query will depend on the engine to which it is submitted. Different query engine interfaces may provide different keywords, operators and so forth. One example using a conventional search engine syntax, the query “events central park new york weekend summer 2009” could be rewritten as:

(“central park” and “new york”) and (summer and 2009 and weekend) and events

Specific search engines may provide additional operators or functions which may provide a more fine grained approach to rewriting a query. Since the query is rewritten using existing facilities within the target search engine, the target search engine need not be modified, or even be aware of the existence of “concepts” within the query.

Second, the query may be rewritten to pass information in the query that explicitly identifies concepts within the query and their relative strength. Such information can then be used by facilities within a search engine to improve search relevance. For example, the above query could include directives including a concept string and a relative concept strength, e.g., concepts (“new york”, 0, “central park”, 0 . . . ), or any other format which comprises equivalent information. Of course, depending on the syntax rules used, queries rewritten to take advantage of a target search engine's query syntax may imply concept information, e.g. “new york” implies concept concept (“new york”,0.)

In one embodiment, concepts and concept strength can be used by a search engine ranking function to rank search results to achieve improved proximity boosting. For example, as documents are returned by a search query, a ranking function within the search engine can calculate one or more proximity features for each document and use such proximity features to rank documents returned to the querying user.

One type of proximity feature that could be calculated for each document is a minimum coverage or smallest window feature. In one embodiment of a smallest window feature, the smallest block of text within a document that includes all of the concepts within query is identified. In another embodiment of a smallest window feature, the smallest block of text within a document that includes the strongest concepts in a query (e.g. category 0 and 1 concepts) is identified. The smaller the identified block of text within a document is, the more likely the document is relevant to the query, and will be ranked accordingly. Other embodiments of a smallest window feature are possible and will be readily apparent to those skilled in the art.

Thus for example, in the case of the query “events central park new york weekend summer 2009”, a document where the concepts of “central park”, “new york”, “summer”, “2009” and “weekend” and “events” all occur in one paragraph is more likely to be relevant than a document where “central park” and “new york” are in one paragraph and “summer”, “2009” and “weekend” and “events” are scattered through other paragraphs in the document.

Another type of proximity feature that could be calculated for each document is a simple metric calculated using strengths of individual concepts times the number of occurrences of the concept in the document, for example,

Proximity=SUM(Conceptₙ(Strength)*Conceptₙ(Number of Occurrences))

which is calculated using all concepts present in the query. Thus for example, in the case of the query “events central park new york weekend summer 2009”, a document where the concept of “central park” occurs twice, “new york” twice, “summer”, “2009” and “weekend” once and “events” once, a value for a proximity feature could be calculated as follows:

“central park”(Strength)*(Occurences)+“new york”(Strength)*(Occurences)+“summer”, “2009”, “weekend”(Strength)*(Occurences)+“events”(Strength)*(Occurences)=(4*2)+(4*2)+(2*1)+(1*1)=19

where, for the purposes of the example, category 0=strength 4, category 2=strength 2, and category 4=strength 1.

Another type of proximity feature that could be calculated for each document is a BM25 or similar bag-of-words function wherein the query is treated, in effect, as a “bag-of-concepts” instead of a bag-of-words.

A proximity feature could be calculated for each document making use of implicit segmentation of the input query to generate a series of overlapping segments wherein the segments may be any consecutive chunk. For example, if query is “san jose air port” implicit segmentation will allow all possible segments in the query, that is “san jose”, “jose air”, “air port”, “san jose air”, “jose air port”, and “san jose air port.” Each of the segments can then be associated with a strength score. A proximity feature can then be calculated based on how closely a document matches all the segments.

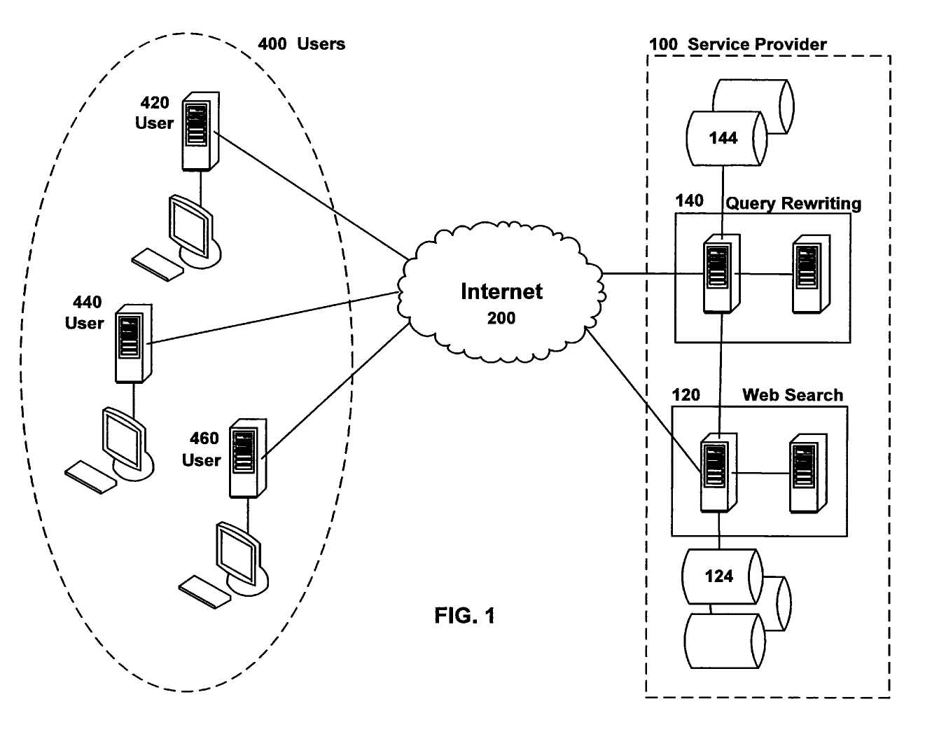

FIG. 1 illustrates a high-level diagram of a system capable of supporting at least one embodiment of a system for improved search relevance using proximity boosting.

A service provider 100 provides web search services including methods for improved search relevance described herein. Web search services are supported by a cluster of servers 120. The web search services can include conventional web search services such as that currently provided by, for example, Yahoo! and Google, and can also include enhanced services, such as ranking with enhanced proximity boosting. The servers 120 are operatively connected to storage devices 124 which can support various databases for supporting web search services such as, for example, directories or indexes.

Query rewriting services, such as those described above are supported by a cluster of servers 140. The servers 140 are operatively connected to storage devices 144 which can support various databases for supporting query rewriting services such as, for example, data for training segmenters. In the illustrated embodiment, the servers providing query rewriting 140 services are shown as a separate cluster of servers from those providing web search services 120, however it should be understood that a single server or cluster of server could support web search service and query rewriting services such as those discussed herein.

The servers providing web search services 120 and query rewriting services 140 are operatively connected to each other and are further connected to an external network such as, for example, the Internet 200. Via the Internet 200, one or more users 400 are operatively connected to the servers 120 and 140, and can access services available on such servers. Users 200 can, inter alia, enter web queries using their respective computing devices. The system can be configured such that queries are initially submitted to web search service servers 120, which can then forward the query to query rewriting servers 140 for query rewriting. Alternatively, the system can be configured such that queries are submitted initially to query rewriting servers 140, which can rewrite the queries and then forward them to web search service servers 120

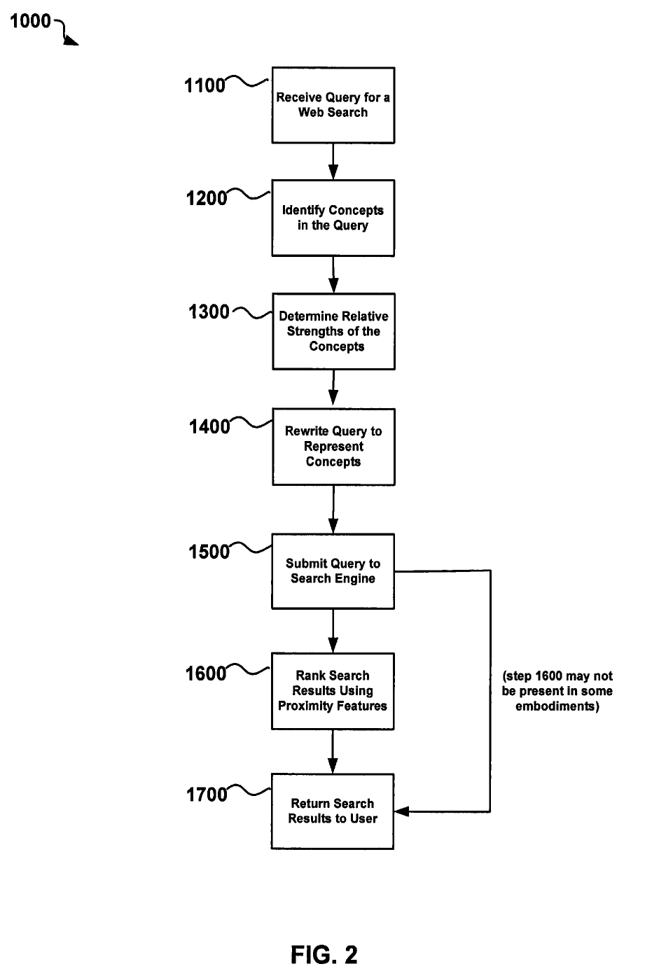

FIG. 2 illustrates one embodiment of a process 1000 for improved search relevance using query rewriting to boost proximity in search results.

The process begins when a web search query is received 1100 from a user, via a network at, for example, a server providing query rewriting services. The query comprises a plurality of query tokens. In a typical web query, the tokens will be words, but they may also could also any other symbol which has meaning to the user entering the query. The user may have entered the query from any device having access to the network such as, for example, desktop computers, laptop computers, PDAs, cell phones and so forth.

The query is then processed by at least one computing device, such as a server, to identify 1200 one or more concepts in the query. In one embodiment, the concepts identified comprise two or more tokens from the plurality of query tokens which, when taken together express an idea or cluster of related ideas, such as, for example, “new” and “york” or “central” and “park.” In one embodiment, concepts are identified using a segmenter or classifier which has been trained to recognize concepts using a training data set produced by, for example, a manually labeled set of queries from a query log. In one embodiment, the classifier or segmenter uses Conditional Random Field techniques (CRF) for segmenting queries.

A relative concept strength is then determined 1300 for each of the concepts which were identified in the previous step. In one embodiment, determining the relative strength of a concept could be a distinct process, or alternatively, could be a by-product of the concept identification step 1200. For example, a segmenter trained to identify concepts may additionally assign a relative strength to the concepts identified at the same time.

In one embodiment, concepts are assigned a relative concept strength reflecting a categorization scheme such as that described in detail above:
category 0: very strong concepts where the words within a concept have to be in the same order and do not allow insertion/deletion of words,
category 1: strong concepts where words within a concept have to be in the same order, but allow word insertion/deletion,
category 2: weak concepts where words can both reverse order and allow word insertion/deletion,
category 3: not a concept (words are not related.)

Other categorization schemes are possible, which may include, for example, more or less categories. The specific scheme used is fine tuned to best support query rewriting strategies which the system implements.

The query is then rewritten 1400 for submission 1500 to a search engine. In one embodiment, for each of the concepts identified, a syntax rule associated with the relative concept strength of the concept is applied to the query tokens comprising the concept such that the rewritten query represents the concepts in one form or another. In one embodiment, the query is rewritten using conventional query syntax that causes the target search engine to boost the proximity of the concepts in the search results. Such syntax may not explicitly identify concepts.

In one embodiment, the query is rewritten to explicitly or implicitly identify concepts and their relative strength within the query using, for example, specific functions, operators or directives or other syntactical elements or constructs that unambiguously identify concepts. Such information may then be used, in one embodiment, by a ranking function within a search engine to boost proximity within ranked search results. In one such embodiment, one or more proximity features are calculated for each document within a search result and the documents are ranked 1600 by the proximity features (note step 1600 may not be present in some embodiments.) Such proximity features may include any technique known in the art, such as those discussed above.

After processing is complete, search results are transmitted back to the user 1700.

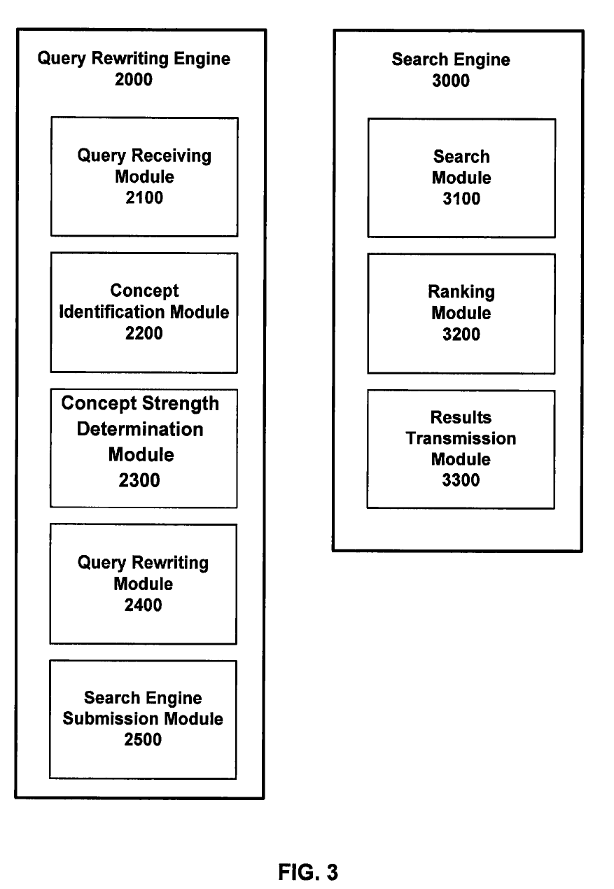

FIG. 3 illustrates one embodiment of a query rewriting engine 2000 and a search engine 3000 capable of supporting at least one embodiment of the process shown in FIG. 2.

The query rewriting engine 2000 comprises a query receiving module 2100, a concept identification module 2200, a concept strength determination module 2300, a query rewriting module 2400 and a search engine submission module 2500. The search engine 3000 comprises a search module 3100, a ranking module 3200 and a results transmission module 3300. The engines 2000 and 3000 could each be implemented on one or more servers or other computing devices. For example, with respect to FIG. 1, the query rewriting engine 2000 could be implemented on the query rewriting servers 140, and the search engine 3000 could be implemented on the web search servers 120. As noted above with respect to FIG. 1, all of these functions and engines could also consolidated in a single server or cluster of servers.

Referring back to FIG. 3, the query receiving module 2100 is configured to receive web search queries from users. The queries comprises a plurality of query tokens. In a typical web query, the tokens will be words, but they could also any other symbol which has meaning to the user entering the query. The user may have entered the query from any device having access to the network such as, for example, desktop computers, laptop computers, PDAs, cell phones and so forth.

The concept identification module 2200 is configured to identify one or more concepts in the queries received by the query receiving module 2100. In one embodiment, the concepts identified comprise two or more tokens from the plurality of query tokens which, when taken together express an idea or cluster of related ideas, such as, for example, “new” and “york” or “central” and “park.” In one embodiment, concepts are identified using a segmenter or classifier in the concept identification module 2200 which has been trained to recognize concepts using a training data set produced by, for example, a manually labeled set of queries from a query log. In one embodiment, the classifier or segmenter uses Conditional Random Field techniques for segmenting queries.

The concept strength determination module 2300 is configured to determine the relative concept strength for each of the concepts identified by the concept identification module 2200. In one embodiment, the concept identification module 2200 and the concept strength determining module 2300 are the same module. For example, a segmenter within the concept identification module 2200 which trained to identify concepts may additionally assign a relative strength to the concepts identified at the same time.

In one embodiment, concepts are assigned a relative concept strength reflecting a categorization scheme such as that described in detail above:
category 0: very strong concepts where the words within a concept have to be in the same order and do not allow insertion/deletion of words,
category 1: strong concepts where words within a concept have to be in the same order, but allow word insertion/deletion,
category 2: weak concepts where words can both reverse order and allow word insertion/deletion,
category 3: not a concept (words are not related.)

Other categorization schemes are possible, which may include, for example, more or less categories. The specific scheme used is fine-tuned to best support query rewriting strategies which the system implements.

The query rewriting module 2400 is configured to rewrite queries processed by the concept identification module 2200 and the concept strength determining module 2300 for submission to a search engine. In one embodiment, for each of the concepts identified in queries processed by the query rewriting module 2400, a syntax rule associated with the relative concept strength of the concept is applied to the query tokens comprising the concept such that the rewritten query represents the concepts in one form or another. In one embodiment, syntax rules for query rewriting are stored on a computer readable medium associated with the query rewriting module 2400.

In one embodiment, the query is rewritten using conventional query syntax that causes the target search engine to boost the proximity of the concepts in the search results. Such syntax may not explicitly identify concepts. In one embodiment, query rewriting module 2400 rewrites queries to explicitly or implicitly identify concepts and their relative strength within the query using, for example, specific functions, operators or directives or other syntactical elements or constructs that unambiguously identify concepts.

The search engine submission module 2500 submits rewritten queries to the search engine 3000 for processing. The search module 3100 within the search engines uses the rewritten queries to search for documents relevant to the query using any search techniques or methods known in the art. The ranking module 3200 ranks search results returned by the search module 3100. In one embodiment, ranking module 3200 uses concept information implicitly or explicitly included in rewritten queries to to boost proximity within ranked search results. In one such embodiment, one or more proximity features are calculated for each document within a search result and the documents are ranked by the proximity features. Such proximity features may include any technique known in the art, such as those discussed above.

The results transmission module 3300 is configured to transmit search results ranked by the ranking module back to querying users.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

We claim:

1. A method comprising the steps of:
receiving a query for a web search from a user, via a network, wherein the query comprises a plurality of query tokens;
identifying, using at least one computing device, one or more concepts in the query, wherein each of the one or more concepts comprises at least two query tokens of the plurality of query tokens;
determining, using the at least one computing device, a respective relative concept strength for each of the one or more concepts;
rewriting the query for submission to a search engine, using the at least one computing device, wherein for each of the one or more concepts, a syntax rule associated with the respective relative concept strength of the concept is applied to the at least two query tokens comprising the concept, such that the rewritten query represents the one or more concepts.

2. The method of claim 1 wherein the rewriting step rewrites the query such that the proximity of the one or more concepts in a search result returned by the search engine to the user in response to the rewritten query is boosted.

3. The method of claim 1 wherein each of the one or more concepts are identified using a segmenter.

4. The method of claim 3 wherein the segmenter is a Conditional Random Field segmenter which was trained using a labeled training data set.

5. The method of claim 1 wherein the relative concept strength of each of the one or more concepts is one of a plurality of categories.

6. The method of claim 5 wherein the plurality of categories comprises:
category 0: concepts where the words within a concept have to be in the same order and do not allow insertion/deletion of words;
category 1: concepts where words within a concept have to be in the same order, but allow word insertion/deletion;
category 2: concepts where words can both reverse order and allow word insertion/deletion;
category 3: not a concept (words are not related.)

7. The method of claim 1 wherein each of the one or more concepts are represented in the rewritten query as a concept string and a concept strength.

8. The method of claim 2 comprising the additional steps of:
searching an index of documents accessible to the network, using at least a second computing device, using the rewritten query, to generate a search result comprising a plurality of documents comprising the one or more concepts;
calculating, using the at least a second computing device, at least one proximity feature for each of the plurality of documents in the search result, wherein the value of the at least one proximity feature reflects the proximity of the one or more concepts within the plurality of documents;
ranking, using the at least one computing device, the plurality of documents by each document's respective at least one proximity feature.

9. The method of claim 8 wherein the first computing device and the second computing device are the same computing device.

10. The method of claim 8 wherein the at least one proximity feature is a smallest window calculation.

11. The method of claim 8 wherein the at least one proximity feature is a bag of words calculation using the one or more concepts in place of words.

12. A system comprising:
a query receiving module that receives queries for web searches from a user, via a network, wherein each query comprises a plurality of query tokens;
a concept identification module that identifies one or more concepts in each query received by the query receiving module, wherein each of the one or more concepts comprises at least two query tokens of the plurality of query tokens;
a concept strength determination module that determines a respective relative concept strength for each of the one or more concepts in each query processed by the concept identification module;
a query rewriting module that rewrites each query processed by the concept identification module and the concept strength determination module for submission to a search engine, wherein for each of the one or more concepts within each query, a syntax rule associated with the respective relative concept strength of the concept is applied to the at least two query tokens comprising the concept, such that the rewritten queries represent the one or more concepts.

13. The system of claim 12 wherein the query rewriting module rewrites the queries such that the proximity of the one or more concepts in a search result returned by the search engine to the user in response to the rewritten query is boosted.

14. The system of claim 12 wherein each of the one or more concepts are identified using a segmenter embodied in the concept identification module.

15. The system of claim 14 wherein the segmenter is a Conditional Random Field segmenter which was trained using a labeled training data set.

16. The system of claim 12 wherein the relative concept strength determined for each of the one or more concepts within each of the queries processed by the concept strength determination module is one of a plurality of categories.

17. The system of claim 16 wherein the plurality of categories comprises:
category 0: concepts where the words within a concept have to be in the same order and do not allow insertion/deletion of words;
category 1: concepts where words within a concept have to be in the same order, but allow word insertion/deletion;
category 2: concepts where words can both reverse order and allow word insertion/deletion;
category 3: not a concept (words are not related.)

18. The system of claim 12 wherein each of the one or more concepts are represented in the rewritten query as a concept string and a concept strength.

19. The system of claim 13 additionally comprising:
a search module that, for each rewritten query, searches an index of documents accessible to the network using the rewritten query, to generate a search result comprising a plurality of documents comprising the one or more concepts represented in the rewritten query;
a ranking module that calculates, for each search result generated by the search module, at least one proximity feature for each of the plurality of documents in the respective search result, wherein the value of the at least one proximity feature reflects the proximity of the one or more concepts in the rewritten query to which the search result relates; wherein the ranking module ranks the plurality of documents by each document's respective at least one proximity feature.

20. The system of claim 19 wherein the at least one proximity feature is a smallest window calculation.

21. The system of claim 19 wherein the at least one proximity feature is a bag of words calculation using the one or more concepts in place of words.

22. A computer-readable medium having computer-executable instructions for a method comprising the steps of:
receiving a query for a web search from a user, via a network, wherein the query comprises a plurality of query tokens;
identifying, using at least one computing device, one or more concepts in the query, wherein each of the one or more concepts comprises at least two query tokens of the plurality of query tokens;
determining, using the at least one computing device, a respective relative concept strength for each of the one or more concepts;
rewriting the query for submission to a search engine, using the at least one computing device, wherein for each of the one or more concepts, a syntax rule associated with the respective relative concept strength of the concept is applied to the at least two query tokens comprising the concept, such that the rewritten query represents the one or more concepts.

23. The computer-readable medium of claim 22 wherein the rewriting step rewrites the query such that the proximity of the one or more concepts in a search result returned by the search engine to the user in response to the rewritten query is boosted.

24. The computer-readable medium of claim 22 wherein each of the one or more concepts are identified using a segmenter.

25. The computer-readable medium of claim 24 wherein the segmenter is a Conditional Random Field segmenter which was trained using a labeled training data set.

26. The computer-readable medium of claim 22 wherein the relative concept strength of each of the one or more concepts is one of a plurality of categories.

27. The computer-readable medium of claim 26 wherein the plurality of categories comprises:
category 0: concepts where the words within a concept have to be in the same order and do not allow insertion/deletion of words;
category 1: concepts where words within a concept have to be in the same order, but allow word insertion/deletion;
category 2: concepts where words can both reverse order and allow word insertion/deletion;
category 3: not a concept (words are not related.)

28. The computer-readable medium of claim 22 wherein each of the one or more concepts are represented in the rewritten query as a concept string and a concept strength.

29. The computer-readable medium of claim 23 comprising the additional steps of:
searching an index of documents accessible to the network, using at least a second computing device, using the rewritten query, to generate a search result comprising a plurality of documents comprising the one or more concepts;
calculating, using the at least a second computing device, at least one proximity feature for each of the plurality of documents in the search result, wherein the value of the at least one proximity feature reflects the proximity of the one or more concepts within the plurality of documents;
ranking, using the at least one computing device, the plurality of documents by each document's respective at least one proximity feature.

30. The computer-readable medium of claim 29 wherein the first computing device and the second computing device are the same computing device.

31. The computer-readable medium of claim 29 wherein the at least one proximity feature is a smallest window calculation.

32. The computer-readable medium of claim 29 wherein the at least one proximity feature is a bag of words calculation using the one or more concepts in place of words.
